(19) United States
(12) Patent Application Publication
(10) Pub. No.: US 2025/0178335 A1
(43) Pub. Date: Jun. 5, 2025

(54) MACHINE FOR CHECKING FLEXOGRAPHIC PRINTING PLATES, OR OFFSET PLATES, OR PRINTING PLATES ASSEMBLIES, OR PRINTED SURFACES

(71) Applicant: Bieffebi S.r.l., Granarolo dell’Emilia (Bologna) (IT)

(72) Inventor: Lorenzo Sambri, Granarolo dell’Emilia (Bologna) (IT)

(21) Appl. No.: 18/925,779

(22) Filed: Oct. 24, 2024

(30) Foreign Application Priority Data
Oct. 24, 2023 (IT) 102023000022305

(51) Int. Cl. B41F 33/00; B41F 5/24

(52) U.S. Cl. CPC B41F 33/0036; B41F 5/24

(57) ABSTRACT

A machine (1) for checking flexographic printing plates, comprising a base (2), a support plane (3), associated with the base (2), for at least one printing plate (4), whose surface characteristics are to be checked and controlled, a control unit (6), and a scanning unit (7) of the surface of the at least one printing plate (4) to be checked. The scanning unit (7) is operationally connected to the control unit (6), and configured to acquire a real image of the at least one printing plate (4) to be checked. The control unit (6) is configured to carry out the comparison between said real image of the at least one printing plate (4), acquired by the scanning unit (7), and the reference image (8) corresponding to the creation file of a printing plate or a plate of multiple printing plates, to avoid assembling erroneous printing plates and related printing tests.

### TECHNICAL FIELD OF THE INVENTION

The present invention relates to a machine for checking flexographic plates. More specifically, the present invention concerns a machine that allows for a preliminary quality control of the flexographic plate so as to avoid the assembly of unsuitable plates and related printing tests.

### BACKGROUND ART

In various printing sectors, and in particular in the flexographic printing sector, with reference, by way of example only, to some application areas such as box factories and the like, but not only, before carrying out a specific printing job, it is necessary to carry out a certain number of tests to verify the quality of the plate used and/or its correct positioning on the printing cylinder.

Such tests can be quite time-consuming, and of course the printing press cannot start operating profitably until the quality and/or positioning checks have given the expected results.

The above tests can be carried out on specific dedicated machines, which have the function of allowing the execution of verification tests on the plates used in the printing job.

By using such testing machines, we avoid having to carry out tests directly on the printing machine, which would be extremely expensive and laborious.

The printing tests performed must then allow the operator to carry out a check, essentially of a visual nature, of the qualitative characteristics of the plate, in order to identify any defects or inaccuracies that could be the consequence of errors in the construction of the plate itself.

To be effective, carrying out these visual checks naturally requires a certain amount of time, and also the skill of an expert operator.

This verification time is inevitably added to the time needed to run the print tests on the dedicated machine.

Furthermore, no matter how quickly these operations can be carried out, a certain margin of uncertainty remains, due to the human factor, namely the visual control carried out by the operator.

Therefore, the need is felt to improve the state of the art in order to limit the time required for mounting unsuitable plates and the related printing tests, and also to be able to eliminate the uncertainties caused by possible errors committed by the operator in charge of quality checks.

In fact, in cases where a plate is found to be affected by errors or inaccuracies, the economic damage for the user can be considerable, especially because a lot of time is wasted in returning the defective plate to the manufacturer, and in producing a replacement with the relative new delivery.

### AIMS OF THE INVENTION

The technical aim of the present invention is therefore to improve the state of the art in the printing sector, in particular—but not only—the flexographic printing sector.

Within such technical aim, it is an object of the present invention to develop a machine for checking flexographic plates which allows the previously mentioned drawbacks to be overcome.

Another aim of the present invention is to make available a machine for checking flexographic plates which allows quality controls to be carried out on a flexographic plate even as soon as it has been produced, and therefore before any other test or inspection.

A further object of the present invention is to provide a machine for checking flexographic plates which is constructionally simple and economical.

Another object of the present invention is to devise a machine for checking flexographic plates which is immediate, intuitive and versatile to use.

This aim and these objects are all achieved by the machine for checking flexographic printing plates according to the attached claim 1.

The machine comprises a base, and a support plane, associated with the base, for at least one plate, the surface characteristics of which must be verified and controlled.

The machine also includes a control unit, and a scanning unit for the surface of the at least one plate to be checked.

The scanning unit is operationally connected to the control unit, and it is configured to acquire a real image of the at least one plate to be checked.

The control unit is configured to perform a comparison between the real image of at least one plate, acquired by the scanning unit, and the reference image corresponding to the creation file of a plate, or to the file of a sheet comprising multiple plates.

The dependent claims refer to preferred and advantageous embodiments of the invention.

According to another aspect of the invention, the scanning unit comprises a carriage, and guide means, provided in the base, for the aforementioned carriage; the carriage is slidable, above the support plane, along a predetermined direction. The scanning unit also comprises at least one scanning sensor installed on the carriage; the scanning sensor is fixed below the lower surface, in use, of the carriage, so as to be positioned facing the support plane, and at a certain distance from the upper surface of the at least one cliché to be checked.

### BRIEF DESCRIPTION OF THE DRAWINGS

These and further advantages will be better understood by any person skilled in the art from the following description and the attached drawings, given as a non-limiting example, in which:

FIG. 1 is an axonometric view of the machine according to the invention;

FIG. 2 is a side view of the machine;

FIG. 3 is a front view of the machine;

FIG. 4 is a top view of the machine;

FIG. 5 is an isometric view of the machine with some parts removed;

FIG. 6 is an axonometric view of the machine with some parts removed, from a different angle;

FIG. 7 is a side view of the machine, with some parts removed;

FIG. 8 is a front view of the machine, with some parts removed;

FIG. 9 is a top view of the machine, with some parts removed;

FIG. 10 is a detail of FIG. 5.

### EMBODIMENTS OF THE INVENTION

With reference to the attached figures, numeral 1 generally indicates a machine for checking flexographic plates according to the present invention.

Machine 1 comprises a base, indicated overall by 2.

Machine 1 also includes a support plane 3.

The support plane 3 is associated with the base 2, and it defines a support surface for at least one plate 4, the surface characteristics of which must be verified and checked.

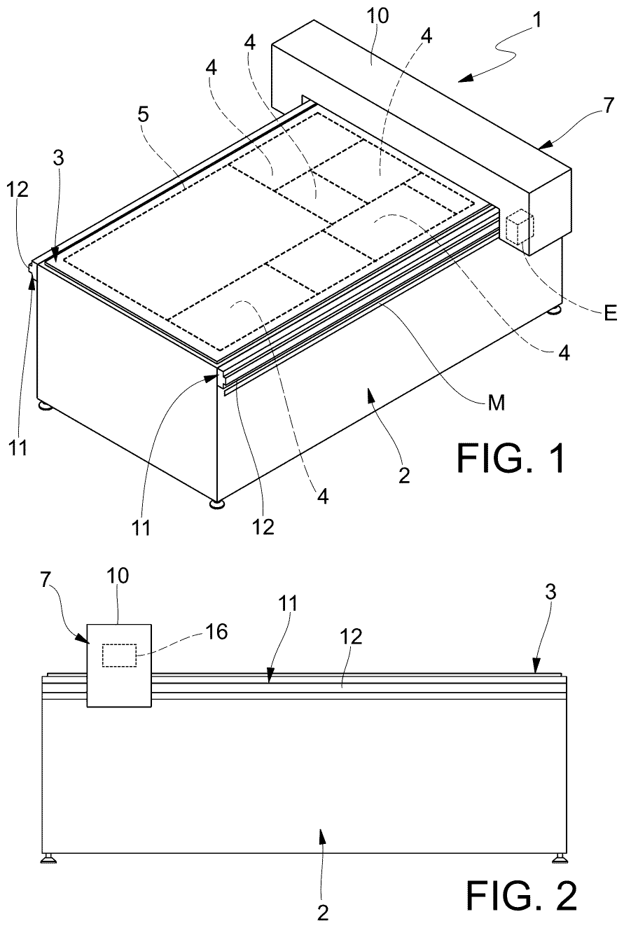

In more detail—and with reference to the schematic representation in FIG. 1—a single sheet 5 (typically made of photopolymer) can also be positioned on the support plane 3, from which various plates 4 will then be obtained by cutting.

This allows for the optimization of the production phase of the plates 4, exploiting, as much as possible, the entire surface of the sheet 5, minimizing waste and scrap. Alternatively, one or more plates 4, already made and finished (i.e. already cut), can also be positioned on the support plane 3, to be checked.

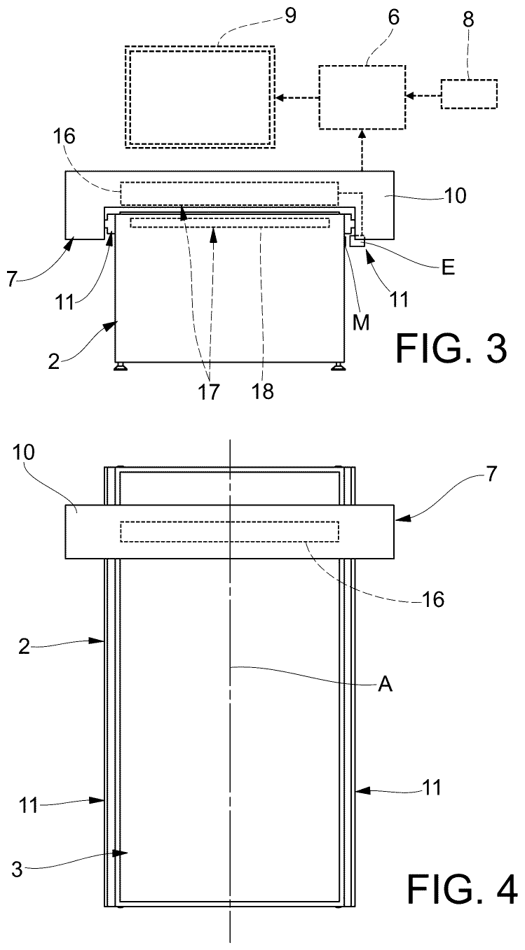

Machine 1 also comprises—and with particular reference to FIG. 3—a control unit 6 (represented schematically); control unit 6 is configured to manage and supervise the operation of machine 1, as better described below.

According to one aspect of the invention, the machine 1 also comprises a scanning unit, indicated overall by 7, of the surface of the at least one plate 4 to be checked. The scanning unit 7 is operationally connected to the control unit 6, and it is configured to acquire a real image of the at least one plate 4 to be checked.

According to another aspect of the invention, the control unit 6 is configured to carry out the comparison between the real image of the at least one plate 4, acquired by the scanning unit 7, and at least one corresponding reference image 8, relating to the creation file of a plate 4, or to the creation file of a sheet 5 comprising multiple plates 4.

In more detail, the at least one reference image 8 can be provided as input to the control unit 6 by the operator responsible for checking the at least one plate 4.

In an embodiment of the invention of particular practical interest, the at least one reference image 8 consists of a graphic file for the creation of a plate 4, or of a sheet 5 comprising several plates 4.

The machine 1 can also be equipped with a user interface 9 (schematically represented in the aforementioned FIG. 3), operationally connected to, and interlocked with, the control unit 6.

Through the aforementioned user interface 9, the operator can set and insert the main parameters (for example, dimensional parameters) and instructions to carry out the verification of the characteristics of one or more plates 4 to be verified.

By means of the aforementioned comparison, the control unit 6 allows to highlight (preferably, but not exclusively, on a screen of the user interface 9) any discrepancies between the real image of the at least one plate 4 and the at least one corresponding reference image 8 of the creation file of a plate 4, or of the creation file of a sheet 5 comprising multiple plates 4, in order to prevent, upstream of any other operational or production step, any errors or inaccuracies in the execution of the print.

More specifically, through the aforementioned comparison, the operator is able to verify, very quickly and precisely, whether a specific plate 4 (or whether each plate 4 positioned on the support plane 3) is suitable, or not, to carry out the printing job or jobs for which it was created.

In other words, the operator is able to easily verify whether a given plate 4 is affected by manufacturing defects of such a nature as to compromise the execution of the printing job or jobs for which it was created.

This saves the time needed to mount unsuitable plates and make test prints, and of course it prevents a print job from being started that will not produce the desired results, if a particular plate 4 is not suitable for it.

This also allows us to avoid having to send the defective plate 4 to the user who requested it.

The comparison between the at least one real image of the at least one plate 4 and the at least one corresponding reference image 8 can be carried out in different ways.

For example, this comparison can be carried out directly and visually by the operator, or specific algorithms can be used to highlight the differences between the images, for a more immediate identification of the same, and therefore for a more immediate identification of any manufacturing defects of the plate 4.

According to the invention, the machine 1, in its different specially developed versions, can carry out, as mentioned, the verification of one or more plates 4 arranged on the aforementioned support plane 3.

In this version of the machine 1, the support plane 3 (and therefore the at least one plate 4 to be checked) is fixed, while the scanning unit 7 moves with respect to it; in other versions of the invention, the scanning unit 7 could instead be kept fixed, while the support plane 3 is movable.

According to one aspect of the invention, the support plane 3 for at least one plate 4 (or for the photopolymer sheet 5, from which several plates 4 will be obtained) comprises at least one sheet of transparent, or translucent, material, for reasons that will become clearer later.

For example, the support plane 3 may comprise at least one glass sheet, transparent or translucent.

According to another aspect of the invention, the scanning unit 7 comprises a carriage 10, and guide means 11 for the said carriage 10; the guide means 11 are provided in the base 2.

The carriage 10 is movable, in a sliding manner, above the support plane 3, that is, in other words, it can translate with respect to the latter.

In more detail, the carriage 10 is movable, above the support plane 3, along a predetermined direction A.

The base 2 of the machine 1 has a roughly box-like shape; on its upper surface the support plane 3 of the at least one plate 4 is installed.

The carriage 10 of the scanning unit 7, on the other hand, is substantially shaped like a portal, and it is wider than the base 2.

The guide means 11 comprise, in more detail, first lateral guides 12, along which the carriage 10 can slide.

The first lateral guides 12 are integral with the lateral sides of the base 2 and, in more detail, they extend along the external sides of the upper side members 13 of the base 2; the first lateral guides 12, therefore, define the sliding direction A of the carriage 10.

The carriage 10 can move along the guide means 11 (and therefore along the first lateral guides 12) manually or, more preferably, automatically.

In this second case, the scanning unit 7 comprises a drive unit, capable of carrying out the translational movement of the carriage 10 itself along the guide means 11.

The drive unit, housed inside the carriage 10, may comprise at least one actuator; said actuator may be of any type suitable for carrying out such translational movement.

In the embodiment illustrated in the attached figures, the drive unit comprises, more specifically, two rotary actuators, for example two electric motors.

The aforementioned actuators are installed at the two ends 14 of the carriage 10. On the output axes of the above actuators are mounted respective toothed wheels (or pinions), which mesh with two respective racks 15, mounted on the base 2 so as to be parallel to the lateral guides 12.

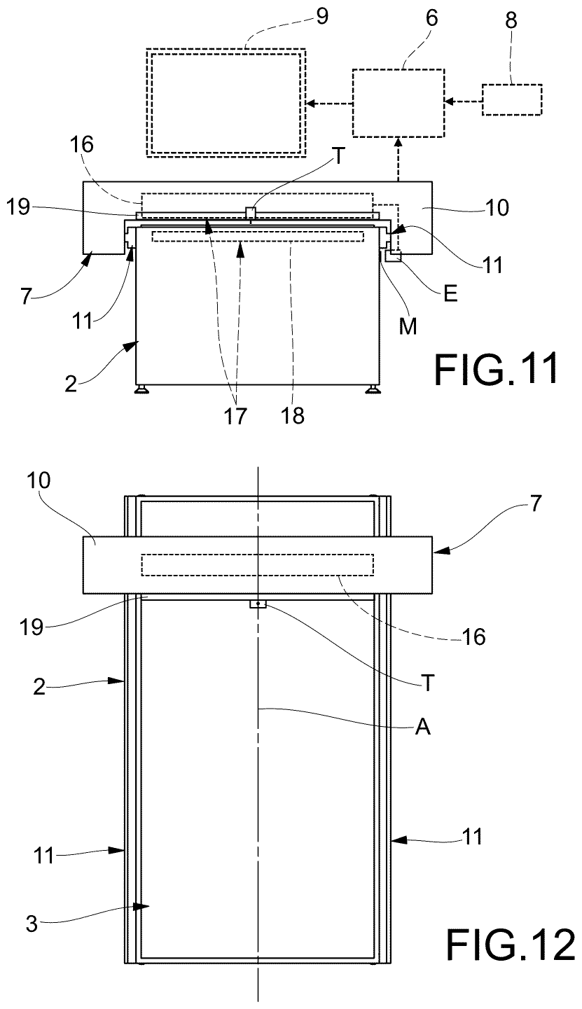

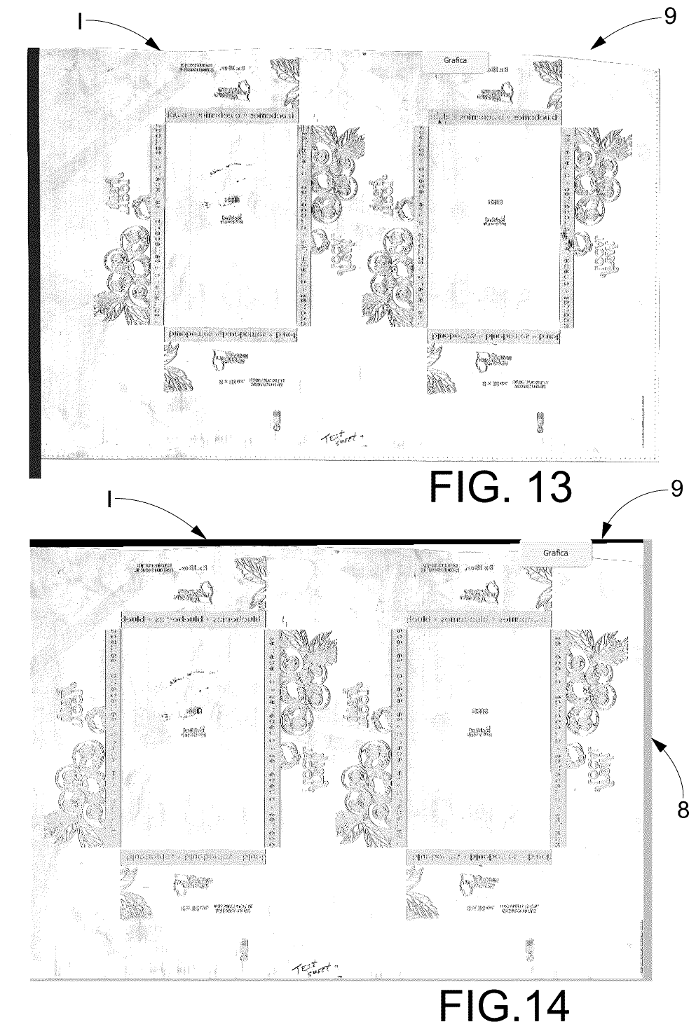

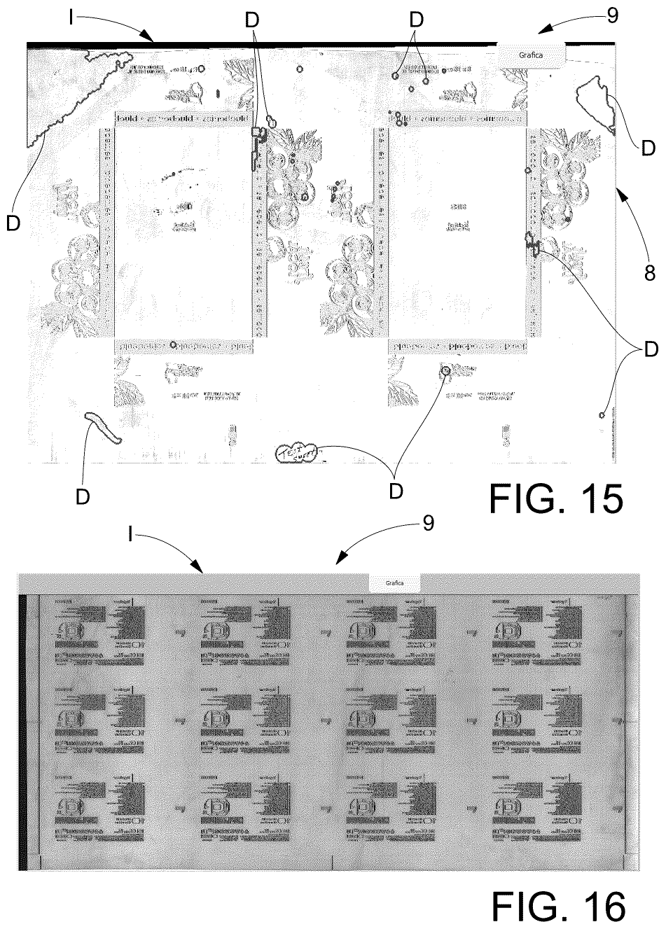

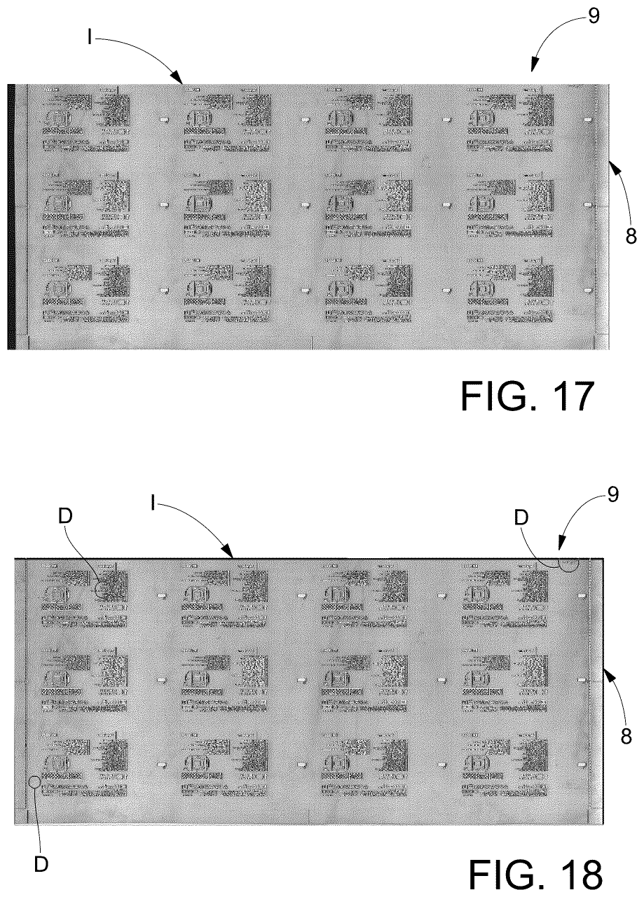

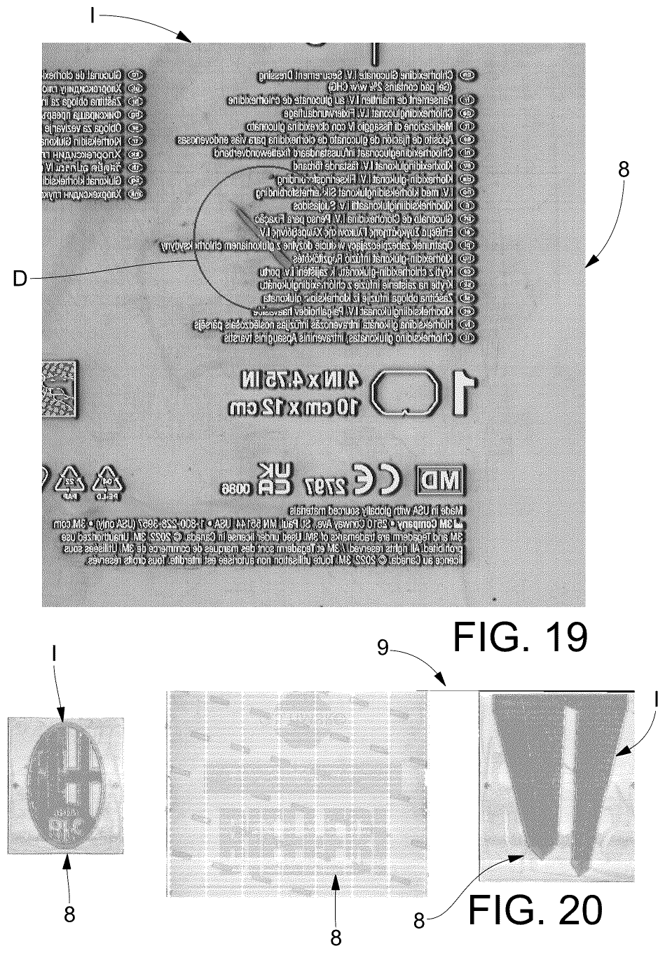

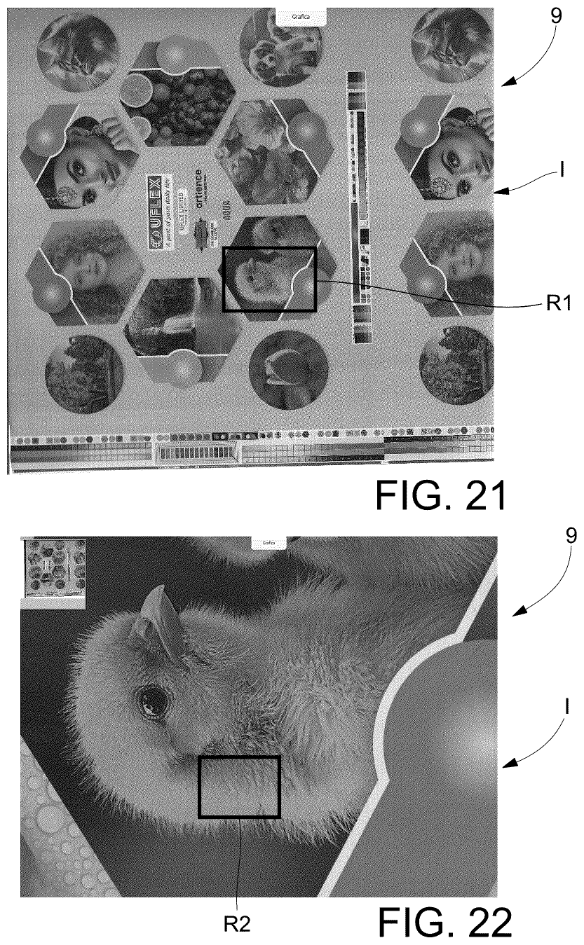

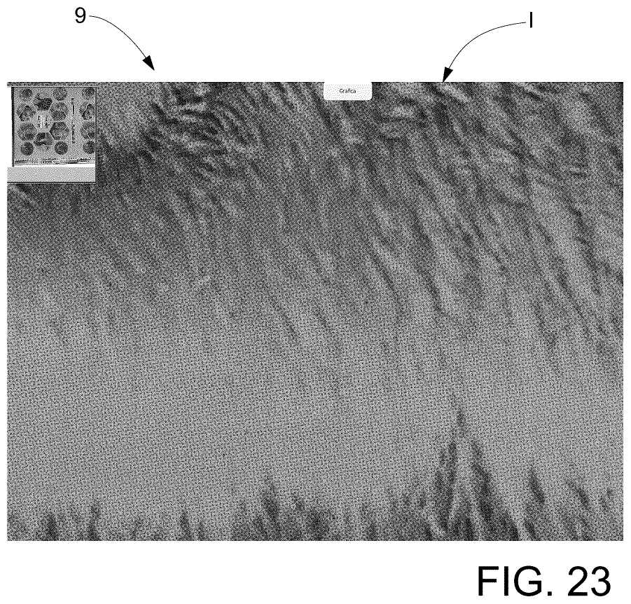

In more detail, as shown in the detail of FIG. 10, the racks 15 are mounted, parallel to the first lateral guides 12, along the external sides of the upper side members 13 of the base 2.

Alternatively, the aforementioned drive unit may comprise a single electric motor, on which a first gear wheel is mounted, which meshes with a first rack 15, placed on one side of the base 2, and a transmission to transmit the motion to a second gear wheel, supported by the carriage 10, which meshes with a second rack 15, placed on the other side of the base 2.

According to another aspect of the invention, the scanning unit 7 comprises at least one scanning sensor 16.

In an embodiment of the invention of particular practical interest, and particularly advantageous, the aforementioned scanning sensor 16 comprises at least one linear sensor, or other type of sensor.

The scanning sensor 16 is installed on the carriage 10.

The aforementioned scanning sensor 16, through a relative motion with respect to the at least one plate 4 (in particular through its translational motion with respect to the plate 4, which is instead kept fixed), and therefore through successive steps, provides for the acquisition of the complete real image of the same.

In the specific case in which a linear sensor, or another type of sensor or camera, is used, the latter produces an image consisting of a single line of pixels; the complete image is constructed by a processor (in this case, that of the control unit 6) exploiting the relative motion between the linear camera itself and the surface of the object (plate 4) of which the image is to be produced.

In this embodiment, the scanning sensor 16 is fixed below the lower, in-use, surface of the carriage 10.

In more detail, the scanning sensor 16 is fixed below the lower surface, in use, of the carriage 10 so as to be positioned facing the support plane 3, and at a certain distance (for example, a few millimetres) from the upper surface of the at least one plate 4 to be checked.

The scanning sensor 16 can be fixed below the lower, in-use, surface of the carriage 10 in an adjustable/registrable manner, to allow the scanning unit 7 to adapt to plates 4 of different thicknesses (for example, typically the thickness of the plates can vary between 1.14 mm to 5 mm).

The adjustment/registration of the scanning sensor 16 with respect to the carriage 10 can also be carried out manually, or in an automated manner, by means of a specifically designed linear actuator.

Both in the case in which the carriage 10 can be moved along the lateral guides 12 manually, and in the case in which it can be moved automatically, the scanning unit 7 can further comprise an encoder (not shown in the figures) which detects the movement of the carriage 10 along the lateral guides 12; the control unit 6, therefore, uses the information provided by the encoder to construct the real image of the at least one plate 4, synchronizing the images taken by the scanning sensor 16 with its movement detected by the aforementioned encoder.

According to another aspect of the invention, the scanning unit 7 comprises a lighting device 17 of the reading area of the scanning sensor 16.

In more detail, the lighting device 17 comprises one or more first lighting bodies, positioned in proximity to the scanning sensor 16 (therefore mounted on the carriage 10).

For example, two first light bodies may be provided, positioned at the two long sides of the scanning sensor 16 (i.e., upstream and downstream of the scanning sensor 16 with reference to the translation direction A of the carriage 10).

Furthermore, the lighting device comprises at least a second lighting body 18 (represented, schematically, in FIG. 3), and translation means 19 of the aforementioned second lighting body 18 below the support plane 3.

The translation means 19 of the second lighting body 18 are configured to advance the second lighting body 18 together with the carriage 10, at the same speed.

The second lighting body 18 can have a width (intended as the dimension perpendicular to the aforementioned translation direction A) such as to also illuminate the larger plates 4 (and therefore can have a width substantially comparable to that of the support plane 3).

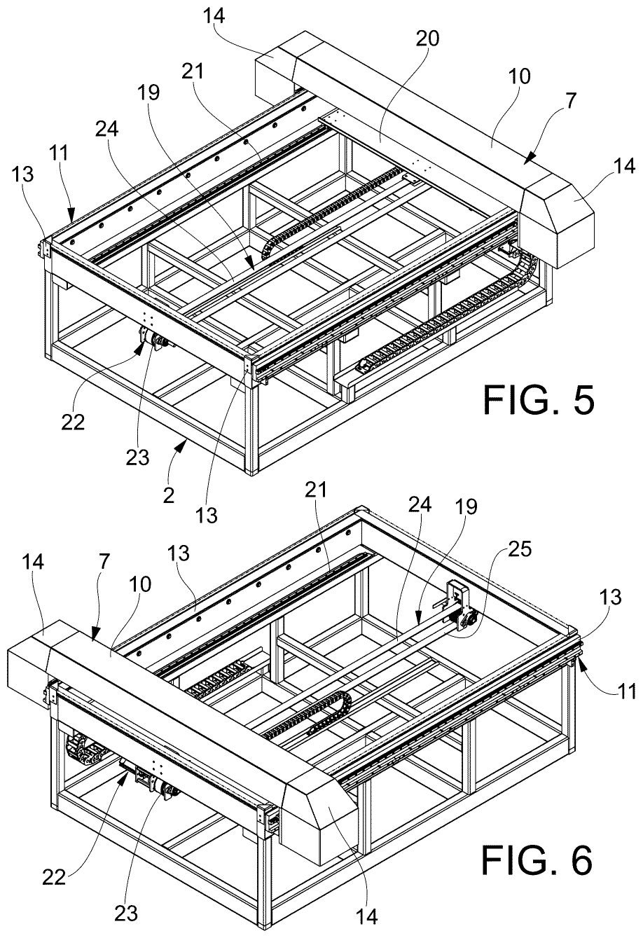

The second lighting body 18 is associated with a respective support 20 (visible, for example, in FIG. 5).

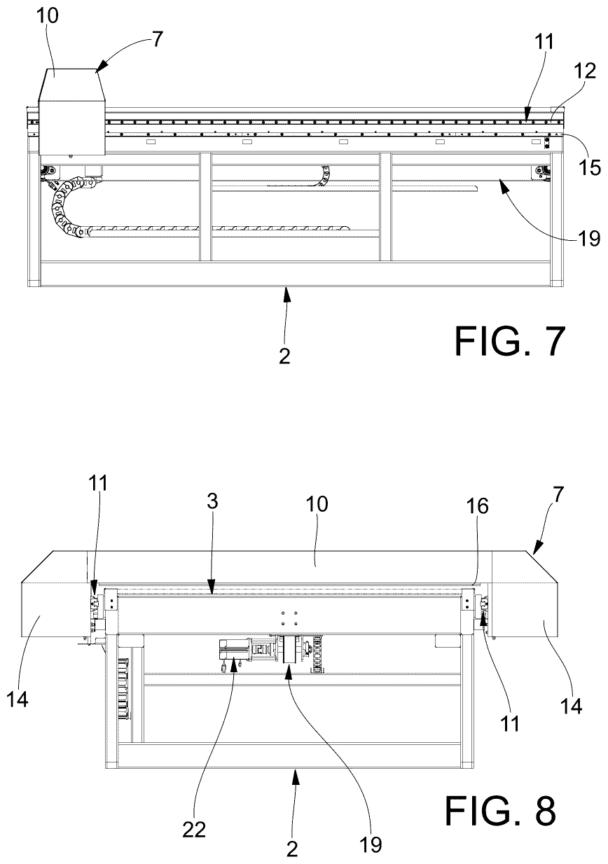

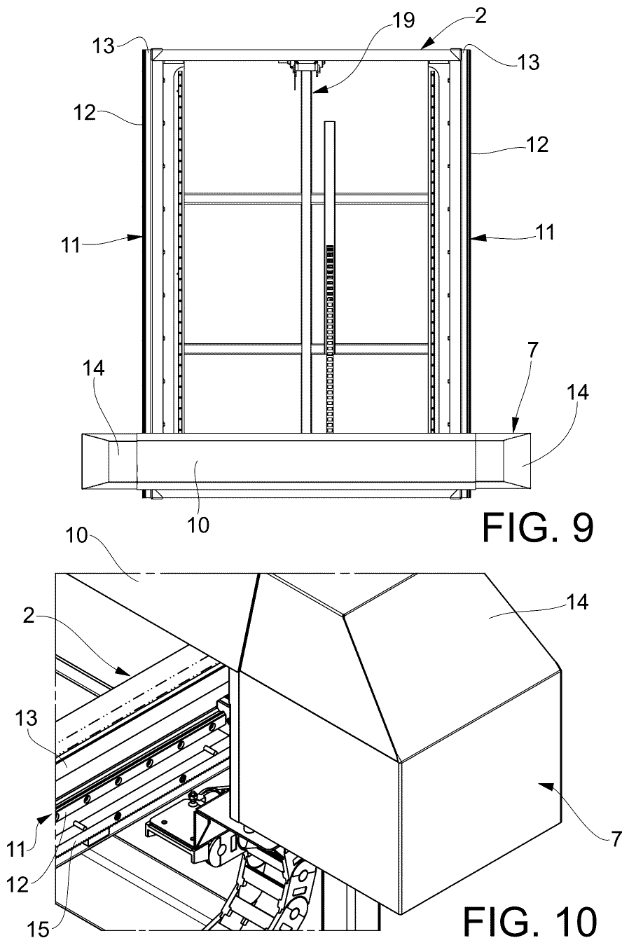

With reference to FIGS. 5-10, which show the machine 1 with some parts of the base 2 removed for greater clarity, the translation means 19 of the second lighting body 18 include second lateral guides 21.

The second lateral guides 21 are fixed to the internal surfaces of the upper side members 13 of the base 2.

The support 20 of the second lighting body 18 comprises, at the respective ends, sliding shoes along the aforementioned second lateral guides 21.

Furthermore, the translation means 19 of the second lighting body 18 can be, for example, of the belt type.

In more detail, in the specific embodiment illustrated in the figures, the translation means 19 of the second lighting body 18 comprise an electric motor 22, on the output axis of which a toothed pulley 23 is mounted.

The electric motor 22 is mounted on the front (or rear, depending on the chosen convention) face of the base 2.

A toothed belt 24, closed in a ring, is wound around the toothed pulley 23 and a further return pulley 25, supported on the face, in rear (or front) use; the support 20 of the second lighting body 18 is in turn fixed to the aforementioned toothed belt 24.

Therefore, the operation of the toothed belt 24 determines the advancement of the support 20 of the second lighting body 18 along the second lateral guides 21, and therefore along the predetermined sliding direction A.

Furthermore, other types of locking/constraint means may be provided for the at least one plate 4 on the support plane 3.

In an alternative embodiment of the machine 1 according to the invention, the scanning unit 7 is fixed with respect to the base 2, and the support plane 3 is slidable, with respect to the scanning unit 7, along a predetermined direction A.

In another alternative embodiment of the machine 1 according to the invention, the scanning unit 7 is fixed with respect to the base 2, and the at least one plate 4 is movable, with respect to the scanning unit 7, by means of a drag system (for example a conveyor belt, or similar).

The operation of the machine 1 according to the invention is, in light of what has been described, completely intuitive.

Once the at least one plate 4 (or more plates 4) to be checked has been positioned (and possibly blocked) on the support plane 3, the machine 1 is started, and then the scanning unit 7, and in particular the carriage 10, starting from one end of the support plane 3 itself, is translated (manually or, more preferably, automatically), along the first guide means 11, so as to progressively cover the entire surface of the at least one plate 4.

The control unit 6 can thus progressively reconstruct the real image of the at least one plate 4 (or of the various plates 4).

Once the acquisition is complete, the carriage 10 stops at the other end of the support plane 3, and then it returns to the starting position to begin another acquisition cycle.

At the same time as the carriage 10 performs its translation and image acquisition stroke, the second lighting body 18 is translated simultaneously with the carriage 10, with the same advancement speed, so as to always be in the correct position with respect to the scanning sensor 16 (preferably, underneath it).

In fact, the transparent or translucent support plane 3 allows the passage of light through the sheet 5 (or at least one plate 4), which is also made of an essentially transparent or translucent photopolymer, thus facilitating detection by the scanning sensor 16.

Subsequently, the real image, acquired by the scanning unit 7, of the at least one plate 4 (or even of the entire sheet 5) can be compared with the corresponding reference image 8, previously supplied as input to the control unit 6 (for example in .pdf format), so as to highlight (also with the aid of special algorithms) any differences between the real image of the at least one plate 4 and the aforementioned reference image 8, which could potentially give rise to an incorrect printing job.

It has thus been seen how the invention achieves the proposed objectives.

The machine is an important tool for the operator in charge of printing, especially flexographic printing, as it allows for preventive verification—and therefore before any other operational or production phase—of the quality of the plate, thus avoiding, possibly, the assembly of unsuitable plates and related printing tests or, even worse, starting an incorrect printing job.

This result is achieved very quickly and extremely reliably, thus significantly limiting possible errors due to the human factor.

The manufacturer thus avoids putting into circulation a plate affected by manufacturing defects that could compromise the printing work.

This saves significant economic and time resources.

The proposed construction solution is very simple, economical, and easy and intuitive to use.

The present invention has been disclosed according to preferred embodiments, but equivalent variants can be conceived without departing from the scope of protection offered by the following claims.

1. Machine (1) for checking flexographic printing plates, characterized in that it comprises
a base (2),
a support plane (3), associated with said base (2), for at least one printing plate (4), the surface characteristics of which are to be checked and controlled,
a control unit (6),
a scanning unit (7) of the surface of the at least one printing plate (4) to be checked,
said scanning unit (7) being operationally connected to said control unit (6), and configured to acquire a real image of the at least one printing plate (4) to be checked,
said control unit (6) being configured to carry out the comparison between said real image of the at least one printing plate (4), acquired by said scanning unit (7), and the reference image (8) corresponding to the creation file of a printing plate or a sheet of multiple printing plates, to avoid assembling erroneous printing plates, printing tests, or erroneous printing.

2. Machine according to claim 1, wherein said scanning unit (7) comprises a carriage (10), and guide means (11), provided in said base (2), for said carriage (10), said carriage (10) being slidable, above said support plane (3), along a predetermined direction (A), or said scanning unit (7) is fixed with respect to said base (2), and said support plane (3) is slidable, with respect to said scanning unit (7), along a predetermined direction (A), or said scanning unit (7) is fixed with respect to said base (2), and said at least one plate (4) is movable with respect to said scanning unit (7) by means of a dragging system.

3. Machine (1) according to claim 2, wherein said scanning unit (7) comprises at least one scanning sensor (16) installed on said carriage (10), said scanning sensor (16) being fixed below the lower surface, in use, of said carriage (10) so as to be positioned facing said support plane (3), and at a given distance from the upper surface of the at least one plate (4) to be checked.

4. Machine (1) according to claim 3, wherein said scanning sensor (16) comprises at least one linear sensor, or other type of sensor.

5. Machine (1) according to one of claims 2-4, wherein said guide means (11) comprise first lateral guides (12) along which said carriage (10) moves, said first lateral guides (12) being integral with the lateral sides of said base (2), and defining said direction (A) of sliding of said carriage (10).

6. Machine according to claim 5, wherein said scanning unit (7) comprises a drive unit suitable for carrying out the translation of said carriage (10) along said guide means (11), said drive unit comprising two rotary actuators, installed at the two ends (14) of said carriage (10), on whose output axes are mounted respective toothed wheels which mesh with two respective racks (15), mounted, on said base (2), parallel to said lateral guides (12).

7. Machine (1) according to one of the preceding claims, wherein said support plane (3) for at least one plate (4) comprises at least one sheet of transparent or translucent material.

8. Machine (1) according to claim 7, wherein said scanning unit (7) comprises a lighting device (18) of the reading area of said scanning sensor (16).

9. Machine (1) according to claim 8, wherein said lighting device (7) comprises at least one lighting body (18) and translation means (19) of said lighting body (18) below said support plane (3), said translation means (19) being configured to advance said lighting body (18) together with said carriage (10), at the same speed.
